(19) United States
(12) Patent Application Publication
(10) Pub. No.: US 2005/0098381 A1
(43) Pub. Date: May 12, 2005

(54) Roofing safety cable system and method

(76) Inventor: Brian J. Flaherty, Alamo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/752,760

(22) Filed: Jan. 7, 2004

Related U.S. Application Data
(60) Provisional application No. 60/513,847, filed on Oct. 23, 2003.

(51) Int. Cl. A62B 1/16

(52) U.S. Cl. 182/3

(57) ABSTRACT

A roofing safety system comprises a plurality of safety cable supports secured along at least a portion of a perimeter of a roof. A safety cable is coupled with, and extends between, at least two of the plurality of safety cable supports. A safety restraint is slidably coupled with the safety cable between at least two of the plurality of safety cable supports.

### RELATED CASE

This application claims the benefit of U.S. Provisional Application No. 60/513847, filed Oct. 23, 2003.

### BACKGROUND OF THE INVENTION

1. Field of the Invention

The present invention relates generally to roofing safety systems, and more particularly to roofing safety cable systems.

2. Description of the Related Art

The perils of working on roofs are well documented. A simple stumble can result in a crippling injury or even death. For this reason, safety regulations typically require that roofing workers utilize one of various prescribed safety devices and in some cases that safety monitors observe workers as they work near an edge of the roof.

Under some circumstances, roofing companies flag the perimeter of a roof, such as on a flat commercial roof, a certain distance from the edge of the roof. This helps to alert the workers when they are approaching an edge of the roof. Additionally, if work must be done close to the edge of the roof, one worker typically is designated a safety monitor that will simply watch the other workers as they work and alert them if they seem to be getting too close to the edge. Having a safety monitor to observe other workers can reduce the overall productivity of the roofing company and generally increases costs and prolongs projects.

In the past, workers typically have constructed a perimeter using wooden studs, plywood and rope. For each new project, the workers typically have to spend time building a new safety perimeter, which can be expensive. In some cases a safety monitor may not be designated to observe workers that need to work outside of the perimeter. Sometimes, even if a safety monitor is designated, the monitor may not be completely attentive, causing the workers near the edge of the roof to be placed in danger.

### SUMMARY OF THE INVENTION

Accordingly, there is a need in the art for a roofing safety system which can be used on a wide variety of roof configurations, which will be both quick and easy to install, which will be comfortable for the worker, which will alert workers as they approach a perimeter of a roof, and which will protect workers in the event of a fall while maximizing the productivity of all workers.

In one embodiment, a roofing safety system comprises a plurality of safety cable supports secured along at least a portion of a perimeter of a roof. Each safety cable support comprises an axially elongated member having a top end, a bottom end, and a safety cable retaining portion. The safety cable retaining portion is configured to receive and support at least a portion of a safety cable extending from the safety cable retaining portion in a first direction and in a second direction along at least a portion of a perimeter of the roof. Each safety cable support comprises a plurality of axially elongated elements bracing or stabilizing the axially elongated member. Each axially elongated element has an inner end and an outer end. The inner ends are coupled with the axially elongated member. Each safety cable support comprises a plurality of feet. Each foot is coupled with one of the axially elongated elements at the outer end and is attached to the roof or an adjacent surface. At least two of the feet are rotatable about non-parallel axes. The roofing safety system comprises a safety cable extending between at least two of the plurality of safety cable supports. The safety cable is coupled with at least two of the plurality of safety cable supports at the safety cable retaining portions. A safety restraint is slidably coupled with the safety cable between at least two of the plurality of safety cable supports. The safety restraint comprises a safety harness and a lanyard for slidably coupling the safety harness to the safety cable.

In another embodiment, a roofing safety system comprises a plurality of safety cable supports secured along at least a portion of a perimeter of a roof. A safety cable is coupled with, and extends between, at least two of the plurality of safety cable supports. A safety restraint is slidably coupled with the safety cable between at least two of the plurality of safety cable supports.

In yet another embodiment, a roofing safety cable support comprises an axially elongated member, having a top end, a bottom end, and a safety cable retaining portion. The safety cable retaining portion is configured to receive and support at least a portion of a safety cable extending from the safety cable retaining portion in a first direction and in a second direction along at least a portion of a perimeter of a roof. The roofing safety cable support comprises a plurality of axially elongated elements for bracing or stabilizing the axially elongated member. Each axially elongated element has an inner end and an outer end. The inner end is configured to be coupled with the axially elongated member. The roofing safety cable support comprises a plurality of feet. Each foot is configured to be coupled with each of the axially elongated elements at each of the outer ends. Each foot is attachable to the roof or adjacent surface. At least two of the feet are rotatable about non-parallel axes.

In another embodiment, a roofing safety cable support comprises an axially elongated member, having a top end and a bottom end. The roofing safety cable support comprises a plurality of axially elongated elements for bracing or stabilizing the axially elongated member. Each axially elongated element has an inner end and an outer end. The inner end is configured to be coupled with the axially elongated member. The roofing safety cable support comprises a plurality of feet. Each foot is configured to be coupled with each of the axially elongated elements at each of the outer ends. Each foot is attachable to a roof or adjacent surface. At least two of the feet are rotatable about non-parallel axes. The roofing safety cable support comprises a means for retaining and supporting a portion of a safety cable extending along at least a portion of a perimeter of the roof. The means for retaining and supporting a portion of a safety cable extending along at least a portion of a perimeter of the roof is coupled with the axially elongated member.

In still another embodiment, a method of securing a roof perimeter comprises securing a plurality of safety cable supports along at least a portion of a perimeter of a roof. Coupling a safety cable with the safety cable supports such that the safety cable extends between at least two of the safety cable supports. Slidably coupling a safety restraint to the safety cable.

Multiple features, aspects and advantages of roofing safety systems are provided in the various embodiments. Advantages of some of the embodiments include use on a wide variety of roof configurations, adjustable and reusable components, quick and easy installation, increased comfort and convenience for workers, establishment of a roof perimeter a safe distance from an edge of the roof to alert workers about the location of the edge, increased strength and stability of a perimeter, increased safety for workers located outside of a perimeter, and increased efficiency and productivity of workers.

### BRIEF DESCRIPTION OF THE DRAWINGS

These and other features of the invention will now be described with reference to drawings of a preferred embodiment which is intended to illustrate, and not to limit, the invention, and in which:

FIG. 1 is a perspective view illustrating a roofing safety system in accordance with one embodiment of the present invention;

FIG. 2 is a perspective view of a portion of the roofing safety system illustrated in FIG. 1;

FIG. 3 is a perspective view of a roofing safety cable support of the roofing safety system illustrated in FIG. 1;

FIG. 4 is an enlarged perspective view illustrating the attachment of a plurality of axially elongated elements to the axially elongated member of the roofing safety cable support of FIG. 3;

FIG. 5 is an enlarged partial perspective view illustrating a foot coupled with an axially elongated element of the roofing safety cable support of FIG. 3; and

FIG. 6 is a perspective view illustrating a use of the roofing safety cable support of FIG. 3 on an irregular roof; and

FIG. 7 is an enlarged perspective view of a safety restraint of the roofing safety system of FIG. 1.

FIG. 8 is an enlarged perspective view of another safety restraint for the roofing safety system of FIG. 1.

### DETAILED DESCRIPTION OF THE PREFERRED EMBODIMENT

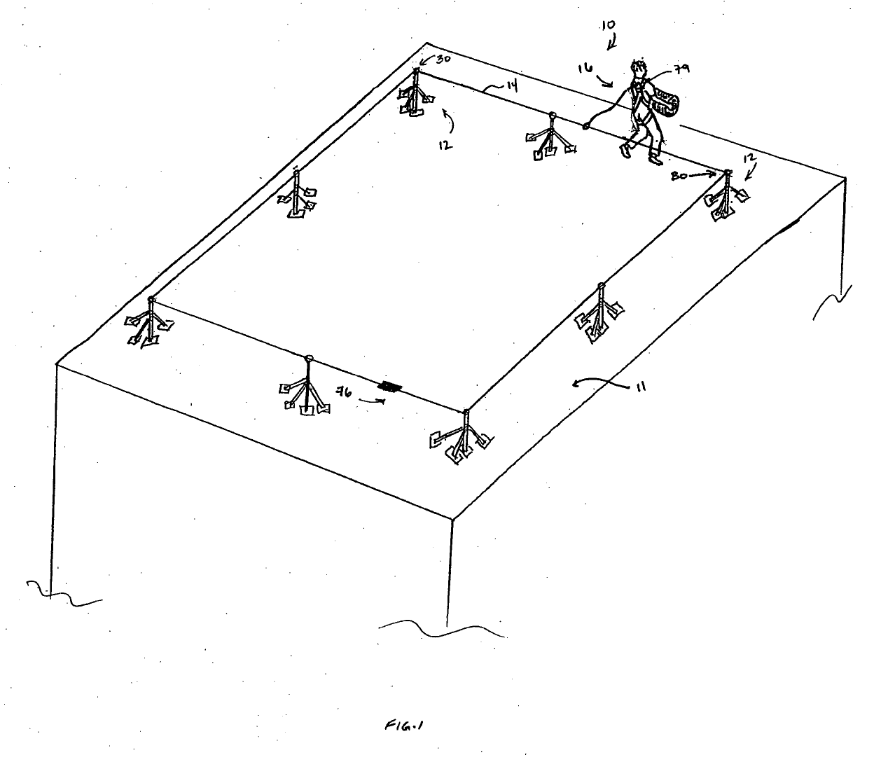

Referring now to the drawings in detail, wherein like reference numerals designate like elements throughout the several views thereof, there is shown generally at 10 an embodiment of a roofing safety system in a preferred form. As illustrated in FIG. 1, the roofing safety system is adapted to be secured to a roof 11.

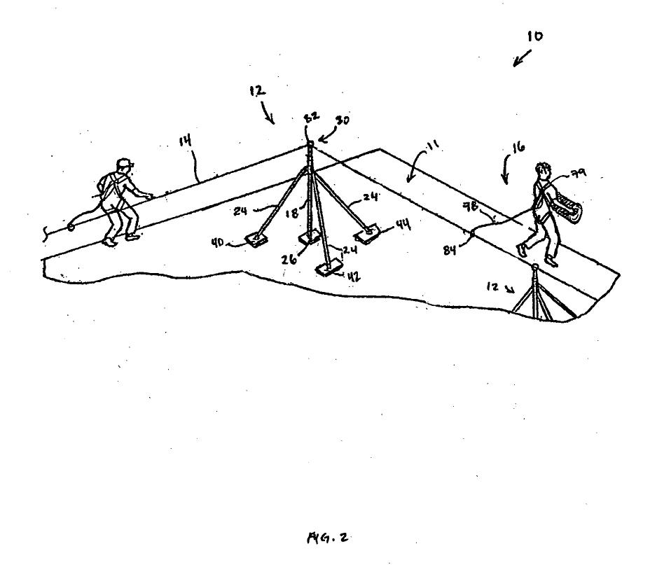

As shown in FIGS. 1 and 2, the roofing safety system comprises a plurality of safety cable supports 12 secured along at least a portion of a perimeter of a roof. The term “perimeter” is used in its ordinary sense (i.e., an outer portion of an area) and is a broad term and it includes a portion of an area extending from about halfway between the center of the area and the edges of the area, outward to the edges of the area. A safety cable 14 is coupled with, and extends between, at least two of the plurality of safety cable supports 12. As shown in the illustrated embodiment, the roofing safety system 10 can have at least 3 safety cable supports, and preferably four or more, so that the safety cable 14, or other safety line, defines a surrounded work area surrounded by the safety cable 14, and an unsurrounded work area comprising a portion of the roof 11 outside of the safety cable 14. A safety restraint 16 is slidably coupled with the safety cable 14 between at least two of the plurality of safety cable supports 12.

The surrounded work area may be any suitable size. Preferably, the surrounded work area is sufficiently large to cover a significant area of the roof. For example, in the illustrated embodiment, the surrounded work area extends to about six feet from the edges of the roof, thereby covering a significant area of the roof. One of skill in the art will recognize that job requirements and other considerations may dictate or suggest the size, location, or configuration of the surrounded area, and it is contemplated that such requirements or considerations can lead to various placements, modifications, or adjustments of various embodiments to achieve a desired result. Furthermore, in some embodiments, it is desirable to configure the roofing safety system to only partially enclose a work area, or to extend only partially along an edge of the roof without surrounding a work area.

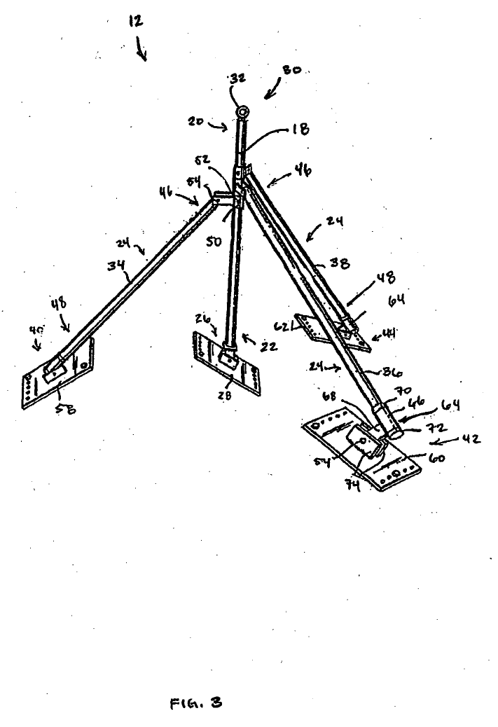

As best seen in FIGS. 1 and 3, one of the plurality of safety cable supports 12 comprises an axially elongated member 18 having a top end 20 and a bottom end 22. The axially elongated member 18 preferably extends vertically when attached to the roof. The axially elongated member 18 preferably is centrally arranged relative axially elongated elements 24, such as, for example, braces or struts, that support the axially elongated member 18 in the vertical position. The axially elongated elements 24 are described further below. A foot 26 is coupled with the bottom end 22 of the axially elongated member 18 for attaching the axially elongated member 18 to the roof. The foot 26 preferably has a flat and rectangular base 28.

The axially elongated member 18 can be any suitable size and comprise any suitable material. The axially elongated member 18 preferably is sufficiently strong to resist bending or breaking under the load of a fallen worker attached to the safety cable 14. In some embodiments, the axially elongated member 18 can be between about 30 inches and about 60 inches tall. Preferably, the axially elongated member 18 is between about 40 inches and about 50 inches tall. The axially elongated member 18 preferably is of such a height that a supported safety cable 14 is not supported so low that it creates a tripping hazard, and yet not so high that workers will not injure their heads or necks on the safety cable 14, or accidentally walk under it. The axially elongated member 18 preferably is made of a rigid material, such as, for example, steel. In some embodiments, the axially elongated member 18 preferably is a 1 inch schedule 40 pipe. The foot 26 of the axially elongated member 18 can be any suitable size and comprise any suitable material. In some embodiments, the base 28 of the foot 26 can be about ⅛ inch thick or more. Preferably, the base 28 of the foot 26 is about ¼ inch thick or more. The foot 26 preferably is made of a rigid material, such as, for example, steel. Steel has significant strength and can be configured for easy attachment to the roof.

The axially elongated member 18 preferably comprises a safety cable retaining portion 30. The safety cable retaining portion 30 is configured to receive and support at least a portion of the safety cable 14 extending from the safety cable retaining portion in a first direction and in a second direction along at least a portion of a perimeter of the roof. As shown in FIG. 2, the safety cable retaining portion 30 is a ring 32. The ring 32 can be any suitable size and comprise any suitable material. In some embodiments, the ring 32 can be between about ½ inch and about 1 inch in diameter. Preferably, the ring 32 is about ¾ inch in diameter. In some embodiments, the ¾ inch diameter ring provides sufficient strength to avoid breaking in the event that a worker falls and places the cable in tension. Additionally, the ¾ inch diameter ring can easily accommodate cable sizes having sufficient strength. The ring 32 preferably is made of a rigid material, such as, for example, steel.

In some embodiments, the roofing safety cable support 12 comprises a means for retaining and supporting a portion of a safety cable 14 extending along at least a portion of a perimeter of the roof 11, coupled with said axially elongated member 18. The means can include the safety cable retaining portion described above, or it can include any of a number of mechanisms, including, for example, but not limited to, a ring, a clamp, a clip, a wedge, an element defining a hole, a strap, a bolt, a brace, a cable, a lock, a cleat or any other suitable structure for achieving the function.

A plurality of axially elongated elements 24 brace or stabilize the axially elongated member 18. The axially elongated elements 24 preferably are sufficiently strong to resist bending or breaking under the load of a fallen worker attached to the safety cable 14. In the illustrated embodiment, the axially elongated elements 24 are a brace 34 and a pair of stabilizing struts 36, 38. As will be discussed in greater detail below, the brace 34 is provided with a foot 40 that is rotatable about an axis perpendicular to the axis of the brace 34. Each strut 36, 38 is provided with a foot 42, 44 that is rotatable about a pair of orthogonal axes. In some embodiments, the ability of the feet 42, 44 of the struts 36,38 to rotate about orthogonal axes permits the safety system 10 to be used in connection with a wide variety of varying roof pitches and stepped roofs which confront the roofer in today's construction environment. In certain embodiments, the axially elongated elements 24 can all be either stabilizing struts or braces. In other embodiments, various combinations of braces and struts can be used.

The axially elongated elements 24 can be any suitable size and comprise any suitable material. In some embodiments, the axially elongated elements 24 can be between about 20 inches and about 70 inches long. Preferably, the axially elongated elements 24 are between about 30 inches and about 60 inches long. The axially elongated elements 24 preferably are long enough to adequately brace and support the axially elongated member 18 on the roof. The axially elongated elements 24 preferably are made of a rigid material, such as, for example, steel. In some embodiments, the axially elongated elements 24 preferably comprise ¾ inch schedule 40 pipe.

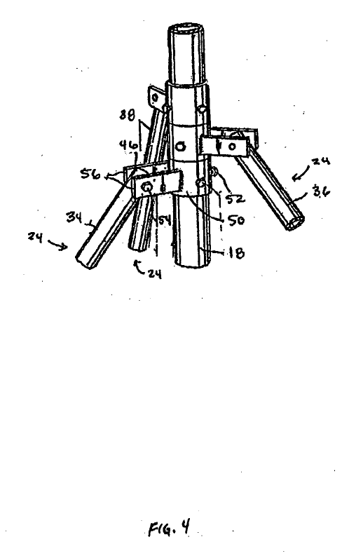

Each axially elongated element 24 has an inner end 46 and an outer end 48. The inner ends 46 are coupled with the axially elongated member 18. The axially elongated elements 24 preferably are adjustably coupled with the axially elongated member 18 through a collar 50 having a lock bolt 52 and a pivot bolt 54. As best illustrated by FIG. 4, the brace 34 and struts 36, 38 are secured to the axially elongated member 18 in the same manner. The cylindrical collar 50 has a pair of radially extending spacer plates 56 and is rotatably secured to the axially elongated member 18 by a plurality of lock bolts 52 or set screws. The inner ends 46 of the axially elongated elements 24 are secured between the spacer plates 56 by means of a pivot bolt 54 or pin having an axis perpendicular to that of the spacer plates 56. Thus, the axially elongated elements 24 can rotate about the axially elongated member 18 when the lock bolts 52 or set screws are loosened, and may also pivot about the pivot bolt 54 or pin. Some examples of coupling mechanisms are disclosed in U.S. Pat. Nos. 4,942,943 and 4,852,692, which are hereby incorporated by reference herein in their entirety.

As shown in FIG. 3, a plurality of feet 40, 42, 44 are coupled with the axially elongated elements 24 at their outer ends 18. The feet 40, 42, 44 preferably have flat and rectangular bases 58, 60, 62. The feet 40, 42, 44 are attachable to the roof 11 or an adjacent surface. The feet 40, 42, 44 of the axially elongated elements 24 can be any suitable size and comprise any suitable material. In some embodiments, the bases 58, 60, 62 of the feet 40, 42, 44 can be about ⅛ inch to about ½ inch thick, or more. Preferably, the bases 58, 60, 62 of the feet 40, 42, 44 are about ¼ inch thick, or more. The feet 40, 42, 44 preferably are made of a rigid material, such as, for example, steel.

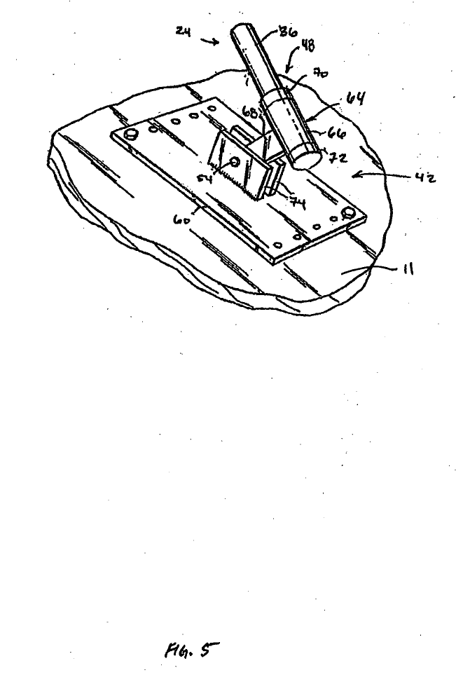

Preferably, at least two of the feet 42, 44 are rotatable about non-parallel axes. With reference to FIGS. 3 and 5, the use of an axially elongated element 24 having a foot 42 with the ability to rotate about a pair of orthogonal axes permits the safety system 10 to be used on a stepped roof. An L-shaped spacer 64 is coupled with the outer end 48 of one of the axially elongated elements 24. The L-shaped spacer 64 comprises a cylindrical sleeve portion 66 and a tongue portion 68.

The sleeve portion 66 is rotatable about the axially elongated element 24. The sleeve portion 66 has an inner diameter slightly larger than the outer diameter of the axially elongated element 24, thereby permitting the free rotation of the spacer 64 about the axially elongated element 24 without significant lateral movement. The sleeve portion 66 is prevented from moving axially along the axially elongated element by two raised cylindrical rings 70, 72 fixed to the axially elongated element 124 axially adjacent either end of the sleeve portion 66 of the spacer 64.

The tongue portion 68 extends radially outward from the sleeve portion 66. The tongue portion 68 is secured between a pair of raised plates 74 extending perpendicularly upward from the base of the foot 42 with a pivot bolt 54 or pin. The tongue portion 68 allows the foot 42 to rotate about an axis perpendicular to the axis of the axially elongated element 24.

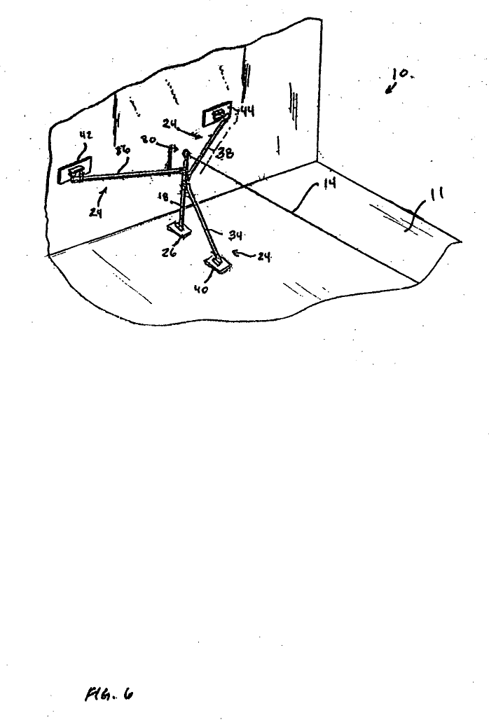

As shown in FIG. 6, the roofing safety system 10 can be used in connection with an irregular roof. The foot 26 of the axially elongated member 18 is aligned with a surface of the roof, preferably over a support beam. An axially elongated element 24, such as for example, the brace 34, is then secured to the roof 11 in a similar manner. The feet 42, 44 of the other axially elongated elements 24, such as, for example, stabilizing struts 36, 38, are rotatable about a pair of orthogonal axes. Accordingly, it is possible to position the struts 36, 38 in a number of various configurations. As depicted in FIG. 6, the struts may be secured to a wall or even to exceptionally steep roofs.

In some embodiments, the ability of the safety cable supports 12 to be used in connection with a variety of roof configurations permits the safety system 10 to be used consistently by the workers so that they become accustomed to working with the safety system 10 regularly. Regular or habitual use strongly increases the likelihood that the safety system 10 will be effectively implemented, eventually resulting in fewer roofing injuries and deaths.

As shown in FIG. 1, the safety cable supports 12 preferably are positioned along a portion of the perimeter of the roof 11 approximately six feet from the edge of the roof. The safety cable 14 preferably extends between at least two of the plurality of safety cable supports 12. The safety cable 14 preferably is a metal cable of a suitable size. The safety cable 14 is coupled with at least two of the plurality of safety cable supports 12 at their safety cable retaining portions 30. The safety cable 14 preferably is sized to cooperate with the safety cable retaining portions 30 of the safety cable supports 12. The safety cable 14 of the illustrated embodiment has a diameter of less than about ¾ of an inch so that it can cooperate with the ring 32 of the axially elongated member 18. The safety cable 14 preferably is sufficiently strong to resist breaking under the load of a fallen worker attached to the safety cable 14. The safety cable 14 preferably is sized to cooperate with the safety cable retaining means of the safety cable supports 12. The safety cable supports 12 and the safety cable 14 preferably define an enclosed roof area. In other embodiments, the safety cable supports 12 and the safety cable 14 can extend along a portion of the roof, such as, for example, along an edge of the roof 11 without defining an enclosed roof area.

The roofing safety system 10 of the illustrated embodiment additionally comprises an anchor means for securing or coupling the safety cable 14 at an anchor location. As shown in FIG. 1, the anchor means comprises a turn buckle 76 coupled with the ends of the safety cable 14 for providing tension in the safety cable 14. The turn buckle 76 preferably comprises a pair of screws coupled with respective ends of the safety cable 14 such that rotation of the turn buckle increases or decreases the tension in the safety cable 14. In other embodiments, a winch, for example, can be bolted to the roof to secure one end of the safety cable 14. The other end of the cable can be coupled with one of the safety cable supports 12 or with an anchor means, for example, with a clip or other suitable fastening means on the end of the safety cable 14. The anchor means can comprise any of a number of mechanisms, including, for example, but not limited to, a turn buckle, a screw, a winch, an anchor, a ring, a clamp, a clip, a wedge, an element defining a hole, a strap, a bolt, a brace, a cable, a lock, a cleat or any other suitable structure for achieving the function.

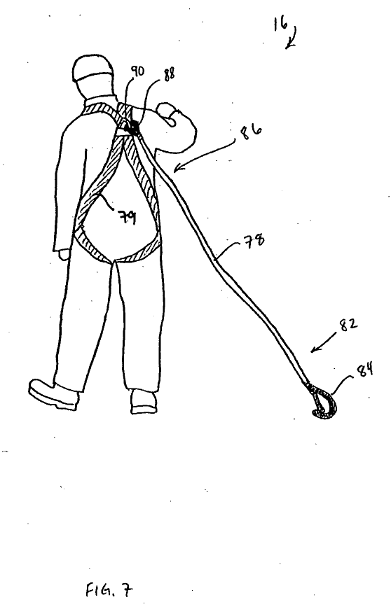

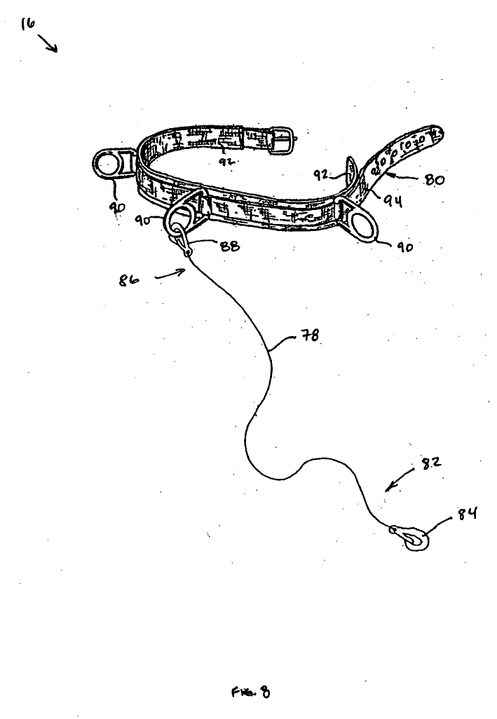

As shown in FIGS. 1, 2, 7 and 8, a safety restraint 16 is slidably coupled with the safety cable 14 between at least two of the plurality of safety cable supports 12. The safety restraint 16 comprises a lanyard 78 for slidably coupling the safety restraint 16 to the safety cable 14. The safety restraint 16 comprises a harness 79, as shown in FIG. 7, or a belt 80, as shown in FIG. 8, securable to the body of a worker on the roof 11 and a means for attaching the lanyard 78 to the harness 79 or belt 80 at one or more locations.

The lanyard 78 preferably comprises a first end 82 having a first fastening mechanism 84 and a second end 86 having a second fastening mechanism 88. The first fastening mechanism 84 preferably is adapted to clip onto the safety cable 14. The second fastening mechanism 88 preferably is adapted to clip onto the harness 79 or belt 80. The harness 79 and belt 80 preferably comprise one or more rings 90 for securing the lanyard 78 to the harness 79 or belt 80.

An exemplary harness 79 is illustrated in FIG. 7. The harness 79 preferably is a fall-arrest harness. As shown, the harness 79 has a D-ring attachment point 90 at the rear between the shoulder blades of the worker. This type of harness is useful where the anchor position is located behind the worker. The harness 79 preferably can be adjusted with two or more buckles. The harness 79 can also comprise an adjustable chest strap (not shown). Other fastening rings can be used.

An exemplary belt 80 of the roofing safety system 10 is illustrated in FIG. 8. The use of a plurality of rings 90, disposed at spaced intervals on the belt 80 permits the worker to secure the lanyard 78 to various sides of the worker's body. The worker can thus perform tasks on the roof 11 without being chafed by the lanyard 78. The belt 80 preferably is double layered, having an interior layer 92 which is cushioned to promote the comfort of the wearer, and an outer heavy layer 94 to enhance the strength of the belt 80. Preferably, three heavy rings 90 are firmly secured to the outer layer 94 of the belt 80 at spaced intervals, corresponding to the hips of the wearer and the small of the wearer's back. It would be possible, of course, to utilize a belt 80 with a single ring to slide about the wearer to permit the worker to utilize the belt 80 without being chafed by the lanyard 78. Experience has shown that unless the safety system 10 is comfortable and convenient for the worker, it will generally not be used by the worker.

A method of securing a roof perimeter comprises securing a plurality of safety cable supports 12 along at least a portion of a perimeter of a roof. Safety cable supports 12 preferably are positioned along a portion of the perimeter of the roof 11 approximately six feet from an edge of the roof. The safety cable supports 12 can be located any suitable distance from an edge of the roof. In some embodiments, safety cable supports 12 can be located between about 2 feet and about 10 feet from an edge of the roof. Moving the perimeter closer to the edge of the roof maximizes the safe work area inside the perimeter. In some cases, it may be desirable to move the perimeter further from the edge, for example, to provide sufficient working space for placing or repairing materials along the edge of the roof outside of the surrounded work area. Preferably, safety cable supports 12 are located between about 4 feet and about 8 feet from an edge of the roof. In some embodiments, establishing a perimeter in this range maximizes the safe work area inside the perimeter while leaving sufficient workspace outside the perimeter to work effectively.

Securing the plurality of safety cable supports 12 along at least a portion of a perimeter of a roof 11 can include aligning a foot 26 of an axially elongated member 18 with a surface of the roof. The foot 26 of the axially elongated member 18 is secured to the surface of the roof. The foot 26 preferably is secured to a support beam of the roof. The feet 42, 44 of at least two axially elongated elements 24 coupled with the axially elongated member 18 are secured to the surface of the roof 11 or to an adjacent surface. The feet 42, 44 preferably are secured to support beams in the roof 11 or in the adjacent surface. The feet 42, 44 of the axially elongated elements 24 are rotatable about non-parallel axes. In some embodiments, at least one of the feet 42, 44 of the axially elongated elements 24 attached to the axially elongated member 18 is secured to a substantially vertical wall.

The method of securing a roof perimeter may additionally comprise coupling a safety cable 14 with the safety cable supports 12 such that the safety cable 14 extends between at least two of the safety cable supports 12. The safety cable supports 12 and the safety cable 14 preferably define an enclosed roof area. In some embodiments, the safety cable 14 is anchored at an anchor location. The method of securing a roof perimeter additionally comprises slidably coupling a safety restraint 16 to the safety cable 14.

The safety system 10 may be used on many types of roofs as a temporary safety system to protect workers on the roof. One particular use is associated with large, generally flat, commercial roofs that do not have a wall along the edge of the roof. A plurality of safety cable supports 12 are placed along the perimeter of a roof 11 approximately six feet from the edge of the roof. The safety cable supports 12 are secured to the roof. A safety cable 14 can be threaded through rings 32 of the safety cable supports 12 and secured.

The safety cable 14 forms a secure perimeter around the roof 11 a safe distance from the edge. The safety cable 14 alerts workers of the location of the edge of the roof 11 and may substitute for a roof monitor that typically watches and informs workers as they are approaching an edge of the roof. If a worker needs to walk or work on the outside of the cable perimeter, the worker can wear a harness 79 or belt 80 of a safety restraint 16 that can be tethered to the safety cable 14 with a lanyard 78. The worker can clip a first end 82 of the lanyard 78 to the safety cable 14 and the second end 86 of the lanyard 78 to the worker's harness 79 or belt 80. The worker can walk along the perimeter of the roof 11 and slide the clip along the safety cable 14 while traveling. If the worker should fall from the roof, the safety cable 14 and safety restraint 16 combination can support the worker until the worker can be assisted.

The roofing safety system 10 is adjustable and can be fastened to a variety of roof configurations. Additionally the safety cable support 12 is quick and easy to set up and is reusable. Because the roofing safety system 10 can be used on many types of roofs and is easy to use, it is more likely that workers will get into the habit of using the system, thereby increasing worker safety. Additionally, the quick set up saves money and time usually associated with constructing a perimeter with wood and rope that must later be broken down and discarded.

The roofing safety system 10 is safer for workers than simply having a safety monitor. By securing the workers to the safety cable 14 using a safety restraint 16 with a harness 79 or belt 80 and lanyard 78, the workers can work near the edge of the roof 11 without concern as to whether the safety monitor is being attentive to their actions, because they will be secured to the roof 11 should they happen to slip and fall. This enables the employer to have a more productive and safe working environment.

Accordingly, advantages of some of the embodiments of the roofing safety system include use on a wide variety of roof configurations, adjustable and reusable components, quick and easy installation, increased comfort and convenience for workers, establishment of a roof perimeter a safe distance from the edge to alert workers about the location of the edge, increased strength and stability of a perimeter, increased safety for workers located outside of a perimeter, and increased efficiency and productivity of workers.

It will be appreciated that certain structural variations may suggest themselves to those skilled in the art. The foregoing detailed description is to be clearly understood as given by way of illustration, the spirit and scope of this invention being limited solely by the appended claims.

1. A roofing safety system, comprising:
a plurality of safety cable supports secured along at least a portion of a perimeter of a roof, wherein each safety cable support comprises:
an axially elongated member, having a top end, a bottom end, and a safety cable retaining portion, wherein said safety cable retaining portion is configured to receive and support at least a portion of a safety cable extending from said safety cable retaining portion in a first direction and in a second direction along at least a portion of a perimeter of the roof;
a plurality of axially elongated elements bracing or stabilizing said axially elongated member, each having an inner end and an outer end, said inner ends coupled with said axially elongated member; and
a plurality of feet, wherein each foot is coupled with one of said axially elongated elements at said outer end and is attached to the roof or adjacent surface, at least two of said feet being rotatable about non-parallel axes;
a safety cable extending between at least two of said plurality of safety cable supports, wherein said safety cable is coupled with said at least two of said plurality of safety cable supports at said safety cable retaining portions; and
a safety restraint slidably coupled with said safety cable between said at least two of said plurality of safety cable supports, wherein said safety restraint comprises a safety harness and a lanyard for slidably coupling said safety harness to said safety cable.

2. The roofing safety system of claim 1, additionally comprising:
at least two L-shaped spacers, one of said L-shaped spacers being coupled with each of said outer ends of said axially elongated elements having feet rotatable about nonparallel axes, each of said L-shaped spacers comprising:
a cylindrical sleeve portion, rotatable about said axially elongated element; and
a tongue portion extending radially outwardly from said sleeve portion, said tongue portion being secured between a pair of raised plates extending perpendicularly upward from each of said feet, whereby said tongue portion allows said foot to rotate about an axis perpendicular to the axis of said axially elongated element.

3. The roofing safety system of claim 1, additionally comprising a foot coupled with the bottom end of said axially elongated member, said foot being attached to the roof.

4. The roofing safety system of claim 1, wherein said feet comprise a flat and rectangular base.

5. The roofing safety system of claim 1, wherein said safety restraint comprises a means for attaching said lanyard to said harness.

6. The roofing safety system of claim 1, wherein said safety cable retaining portion comprises a ring.

7. The roofing safety system of claim 1, wherein said axially elongated elements are adjustably coupled with said axially elongated member through a collar having a lock bolt and a pivot bolt.

8. The roofing safety system of claim 1, wherein said safety cable supports are positioned along a portion of the perimeter of the roof approximately six feet from the edge of the roof

9. The roofing safety system of claim 1, wherein said safety cable supports and said safety cable define an enclosed roof area.

10. The roofing safety system of claim 1, additionally comprising an anchor means for securing said safety cable at an anchor location.

11. A roofing safety system, comprising:
a plurality of safety cable supports secured along at least a portion of a perimeter of a roof,
a safety cable, wherein said safety cable is coupled with, and extends between, at least two of said plurality of safety cable supports; and
a safety restraint slidably coupled with said safety cable between at least two of said plurality of safety cable supports.

12. The roofing safety system of claim 11, wherein said safety restraint comprises:
a harness or belt securable to the body of a worker on the roof;
a lanyard for slidably coupling said harness or belt to said safety cable; and
a means for attaching said lanyard to said harness or belt at a plurality of locations.

13. The roofing safety system of claim 11, wherein said safety cable supports are positioned along a portion of the perimeter of the roof approximately six feet from the edge of the roof.

14. The roofing safety system of claim 11, wherein said safety cable supports and said safety cable define an enclosed roof area.

15. The roofing safety system of claim 11, additionally comprising an anchor means for securing said safety cable at an anchor location.

16. The roofing safety system of claim 11, wherein the safety cable comprises a fastening element at a first end for securing the safety cable at an anchor location.

17. The roofing safety system of claim 11, wherein the safety cable support defines an annular surface for surrounding the safety cable.

18. A roofing safety cable support, comprising:
an axially elongated member, having a top end, a bottom end, and a safety cable retaining portion, wherein said safety cable retaining portion is configured to receive and support at least a portion of a safety-cable extending from said safety cable retaining portion in a first direction and in a second direction along at least a portion of a perimeter of a roof;
a plurality of axially elongated elements for bracing or stabilizing said axially elongated member, each having an inner end and an outer end, said inner end configured to be coupled with said axially elongated member; and
a plurality of feet, each foot being configured to be coupled with each of said axially elongated elements at each of said outer ends and attachable to the roof or adjacent surface, at least two of said feet being rotatable about non-parallel axes.

19. The roofing safety cable support of claim 18, additionally comprising:
at least two L-shaped spacers, said L-shaped spacers capable of being coupled with said outer ends of said axially elongated elements having feet rotatable about nonparallel axes, each of said L-shaped spacers comprising:
a cylindrical sleeve portion, rotatable about said axially elongated element; and
a tongue portion extending radially outwardly from said sleeve portion, said tongue portion securable between a pair of raised plates extending perpendicularly upward from each of said feet, whereby said tongue portion allows said foot to rotate about an axis perpendicular to the axis of said axially elongated element.

20. The roofing safety cable support of claim 18, additionally comprising a foot adapted to be coupled with the bottom end of said axially elongated member, said foot being attachable to the roof.

21. The roofing safety cable support of claim 18, wherein said feet comprise a flat and rectangular base.

22. The roofing safety cable support of claim 18, wherein said safety cable retaining portion comprises a ring.

23. A roofing safety cable support, comprising:
an axially elongated member, having a top end and a bottom end;
a plurality of axially elongated elements for bracing or stabilizing said axially elongated member, each having an inner end and an outer end, said inner end configured to be coupled with said axially elongated member;
a plurality of feet, each foot being configured to be coupled with each of said axially elongated elements at each of said outer ends and attachable to a roof or adjacent surface, at least two of said feet being rotatable about non-parallel axes; and
a means for retaining and supporting a portion of a safety cable extending along at least a portion of a perimeter of the roof coupled with said axially elongated member.

24. The roofing safety cable support of claim 23, wherein said means for retaining and supporting a portion of a safety cable extending along at least a portion of a perimeter of the roof comprises a ring.

25. A method of securing a roof perimeter, comprising:
securing a plurality of safety cable supports along at least a portion of a perimeter of a roof;
coupling a safety cable with said safety cable supports such that said safety cable extends between at least two of said safety cable supports; and
slidably coupling a safety restraint to said safety cable.

26. The method of claim 25, wherein securing a plurality of safety cable supports comprises:
aligning a foot of an axially elongated member with a surface of the roof;
securing the foot of said axially elongated member to the surface of the roof; and
securing feet of at least two axially elongated elements coupled with said axially elongated member to the surface of the roof or to an adjacent surface, said feet being rotatable about non-parallel axes.

27. The method of claim 25, wherein said feet are secured to a support beam.

28. The method of claim 25, wherein at least one of said feet of said axially elongated elements attached to said axially elongated member is secured to a substantially vertical wall.

29. The method of claim 25, wherein said safety cable supports are positioned along a portion of the perimeter of the roof approximately six feet from the edge of the roof.

30. The method of claim 25, wherein said safety cable supports and said safety cable define an enclosed roof area.

31. The method of claim 25, additionally comprising anchoring said safety cable at an anchor location.
